(19) United States
(12) Patent Application Publication
(10) Pub. No.: US 2023/0128814 A1
(43) Pub. Date: Apr. 27, 2023

(54) MASSAGE SYSTEM AND DEVICE

(71) Applicant: OSIM International Pte Ltd, Singapore (SG)

(72) Inventors: Sim Kat CHONG, Singapore (SG); Yikang SUN, Singapore (SG); Mingqian Charles LI, Singapore (SG); Dengfeng ZHOU, Singapore (SG); Kee Perng SOO, Singapore (SG)

(73) Assignee: OSIM International Pte Ltd, Singapore (SG)

(21) Appl. No.: 17/891,502

(22) Filed: Aug. 19, 2022

(30) Foreign Application Priority Data
Oct. 27, 2021 (SG) 10202111920U

(51) Int. Cl. G06F 3/04886; A61H 15/00; G06F 3/04847; G06F 3/04842

(52) U.S. Cl. CPC G06F 3/04886; A61H 15/0078; G06F 3/04842; G06F 3/04847; A61H 2201/0149; A61H 2201/5046; A61H 2201/5064; A61H 2205/062

(57) ABSTRACT

A massage chair and an input device in data communication with the massage chair is disclosed. The massage chair has several massaging mechanisms, each of which is for massaging a corresponding one of a number of body parts of a user. The input device includes a touch screen display. The input device is operable to display on the touch screen display a body part selection screen. This body part selection screen includes a human body representation and a number of body part representations corresponding to the body parts of the user. Each body part representation is individually selectable for actuating a corresponding massaging mechanism to massage a corresponding body part of the user. One of more of the plurality of body part representations is of an irregular shape and of a size that at least substantially covers a corresponding body part of the human body representation.

### CROSS-REFERENCE TO RELATED APPLICATION

The present application claims the right of priority to and the benefit of Singapore Application No. 10202111920U having a filing date of Oct. 27, 2021, the contents of which is hereby incorporated by reference in its entirety.

### TECHNICAL FIELD

This invention relates a massage system. More particularly, this invention relates to a massage chair and a method for operating the massage chair using an input device.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Massage apparatus, such as a massage chair, is operated using a remote controller. One such remote controller is a mobile phone running an appropriate app. Existing apps often come with a predefined list of massage programs. A user customizable program for massaging specific body parts is usually not available. And where available, the app for making such customization is often not very user friendly and difficult to navigate. They often involve multiple complicated flows. Furthermore, instructions for navigation where available are often in text. This further complicates operation for those who do not understand the text. The user interface for such apps is thus not very intuitive.

There is therefore a need for a massage system which addresses, at least in part, one or more of the forgoing problems.

### SUMMARY

According to an aspect of the present disclosure, there is provided a massage system that includes a massage chair and an input device in data communication with the massage chair. The massage chair has several massaging mechanisms, each of which is for massaging a corresponding one of a number of body parts of a user. The input device includes a touch screen display. The input device is operable to display on the touch screen display a body part selection screen. This body part selection screen includes a human body representation and a number of body part representations corresponding to the body parts of the user. Each body part representation is individually selectable for actuating a corresponding massaging mechanism to massage a corresponding body part of the user. One of more of the plurality of body part representations is of an irregular shape and of a size that at least substantially covers a corresponding body part of the human body representation.

In some embodiments of the system, the irregular shape includes a number of border segments, each of which is being defined according to a cubic Bezier curve.

In some embodiments of the system, the input device defines an irregular polygon based on the irregular shape.

In some embodiments of the system, detecting whether the irregular shape is selected by a touch is based on whether the touch is within the irregular polygon.

In some embodiments of the system, determining whether the touch is within the irregular polygon is based on a Jordan curve theorem.

In some embodiments of the system, the irregular polygon includes vertices that lie on a border of the irregular shape.

In some embodiments of the system, the irregular shape includes a number of border segments and at least one of them follows a contour of the corresponding body part of the human body representation.

In some embodiments of the system, each body part representation is further selectable for adjusting one or more parameters of the corresponding massaging mechanism.

In some embodiments of the system, each body part representation is selectable for selecting the corresponding massaging mechanism via a tap and selectable for adjusting the one or more parameters of the corresponding massaging mechanism via either a press, a slide gesture or a double-tap.

In some embodiments of the system, the input device is further operable to display a parameter adjustment screen when a body part representation is selected for adjusting the one or more parameters of the corresponding massaging mechanism. The parameter adjustment screen includes the human body representation with the selected body part representation distinguished from the other body part representations; and the one or more parameters for adjustment adjacent the human body representation.

In some embodiments, the parameter adjustment screen further includes a massage button that is actuatable before adjustment of the one or more parameters can proceed.

In some embodiments, the massaging mechanisms include a shoulder massaging roller whose position along a backrest of the massage chair is selectable in a shoulder roller positioning mode. In this mode, the input device is further operable to display in a shoulder roller positioning screen a representation of the shoulder massaging roller and a representation of the backrest, wherein a position of the shoulder massaging roller representation along the backrest representation is shown in synchronization with a movement of the shoulder massaging roller along the backrest of the massage chair.

In some embodiments, the massage chair includes a number of sensors for detecting the position of the shoulder massaging roller along the backrest. The massage chair sends positional information to the input device as each of the sensors detects the shoulder massaging roller in its proximity for the input device to position the shoulder massaging roller representation in a corresponding position in the shoulder roller positioning screen.

In some embodiments, the shoulder roller positioning screen includes a human body representation that appears only after the position of the shoulder massaging roller has been selected; the human body representation having a shoulder portion that is adjacent the shoulder massaging roller representation.

According to another aspect of the present disclosure, there is provided a device in data communication with a massage chair having a number of massaging mechanisms. Each massaging mechanism is for massaging a corresponding one of a number of body parts of a user. The device includes touch screen display. The device is operable to display on the touch screen display a body part selection screen. The body part selection screen includes a human body representation and a number of body part representations corresponding to the body parts of the user. Each body part representation is individually selectable for actuating a corresponding massaging mechanism to massage a corresponding body part of the user. One or more of the body part representations is of an irregular shape and of a size that at least substantially covers a corresponding body part of the human body representation.

In some embodiments of the device, the irregular shape includes a plurality of border segments, each border segment being defined according to a cubic Bezier curve.

In some embodiments of the device, an irregular polygon is defined based on the irregular shape.

In some embodiments of the device, detecting whether the irregular shape is selected by a touch is based on determining whether the touch is within the irregular polygon.

In some embodiments of the device, determining whether the touch is within the irregular polygon is based on a Jordan curve theorem.

In some embodiments of the device, wherein vertices of the irregular polygon lie on a border of the irregular shape.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is a schematic diagram of a massage system according to an embodiment of the invention, the massage system including a massage chair and a mobile phone used as an input device;

FIG. 2 is a block diagram showing components of the massage chair in FIG. 1;

FIG. 3 is a flow diagram showing a method of operating the massage chair in FIG. 1;

FIGS. 4-6 are drawings showing shoulder roller positioning screens viewable on the input device in FIG. 1 during a shoulder roller positioning mode of the massage system in FIG. 1;

FIG. 7 is a schematic drawing of the massage chair in FIG. 1 showing a shoulder massaging roller in a backrest of the massage chair;

FIGS. 8-13 are drawings showing body part selection screens viewable on the input device in FIG. 1 during a body part selection mode of the massage system in FIG. 1;

FIGS. 14-16 are drawings showing a butt and thigh body part representation and how a touch therein is detectable;

FIG. 17 is a drawing showing a massaging screen viewable on the input device in FIG. 1 during a massage mode of the massage system in FIG. 1; and

FIGS. 18-35 are drawings showing parameter adjustment screens for adjusting various massaging mechanisms viewable on the input device in FIG. 1 during a parameter adjustment mode of the massage system in FIG. 1.

### DESCRIPTION OF THE EMBODIMENTS

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Throughout the description, it is to be appreciated that the term ‘processor’ and its plural form include microcontrollers, microprocessors, programmable integrated circuit chips such as application specific integrated circuit chip (ASIC), computer servers, electronic devices, and/or combination thereof capable of processing one or more input electronic signals to produce one or more output electronic signals. The processor includes one or more input modules and one or more output modules for processing of electronic signals.

Throughout the description, it is to be appreciated that the term ‘server’ and its plural form can include local, distributed servers, and combinations of both local and distributed servers.

Unless defined otherwise, all technical and scientific terms used herein have the same meaning as is commonly understood by a skilled person to which the subject matter herein belongs.

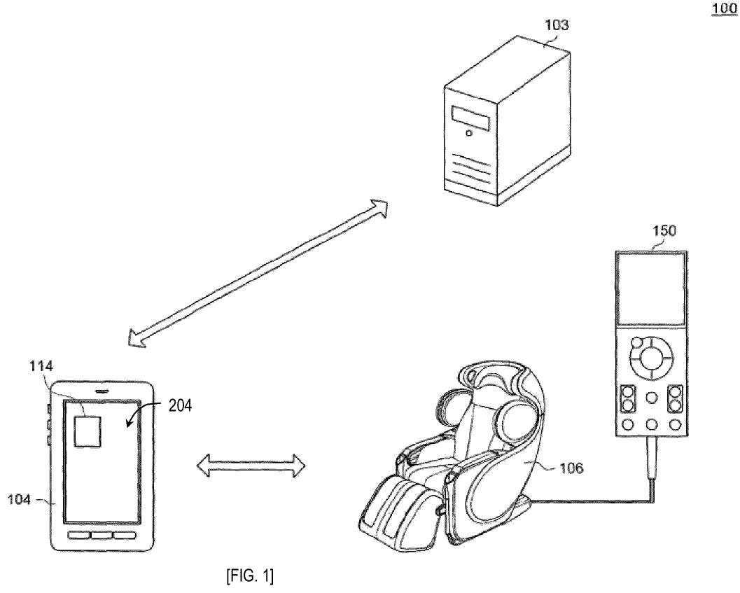

As shown in the drawings for purposes of illustration, the invention may be embodied in a novel and user-friendly massage system. Existing systems tend to be not so user friendly and intuitive to use. Referring to FIG. 1, a massage system includes a massage chair and an input device in data communication with the massage chair. The massage chair includes a number of massaging mechanisms, each of which is for massaging a corresponding one of a number of body parts of a use. The input device includes a touch screen display and is operable to display on the touch screen display a body part selection screen. This body part selection screen includes a human body representation and a number of body part representations corresponding to the body parts of the user. Each body part representation is individually selectable for actuating a corresponding massaging mechanism to massage a corresponding body part of the user. One or more of the body part representations is of an irregular shape and of a size that at least substantially covers a corresponding body part of the human body representation.

Specifically, FIG. 1 is a schematic diagram illustrating an embodiment of a massage system 100 according to an embodiment of the present disclosure. The system 100 includes a server computer 103, a terminal device 104 and a massage chair 106.

The server computer 103 stores a number of massage programs that are executable on the massage chair 106. The server computer 103 connects with the terminal device 104 to transfer one or more of the massage programs via the terminal device 104 to the massage chair 106. In one embodiment, the server computer 103 can be maintained and operated by a seller of the massage programs. In other embodiments, the massage programs can be stored in the massage chair 106 and/or the terminal device 104.

The terminal device 104 may be a smart phone, a tablet computer, a laptop computer, a personal computer, or any device that is suitable to be used as an input device. The terminal device 104 executes an application program 114 that allows the terminal device 104 to interact with the server computer 103 and the massage chair 106 for providing massage related services. More specifically, the application program 114 executed on the terminal device 104 can connect with the server computer 103 to, for example, receive notifications about the release of new massage programs, and downloading the massage program from the server computer 103. The application program 114 can also connect with the massage chair 106 to conduct various tasks including, for example, displaying current settings of the massage chair 106, transferring a massage program to the massage chair 106, and controlling certain functionality of the massage chair 106 including but not limited to adjusting a position of a shoulder massaging roller 200 (FIG. 7) and creating a customized program for massaging selected body parts of a user. Such functionalities will be described in more detail later.

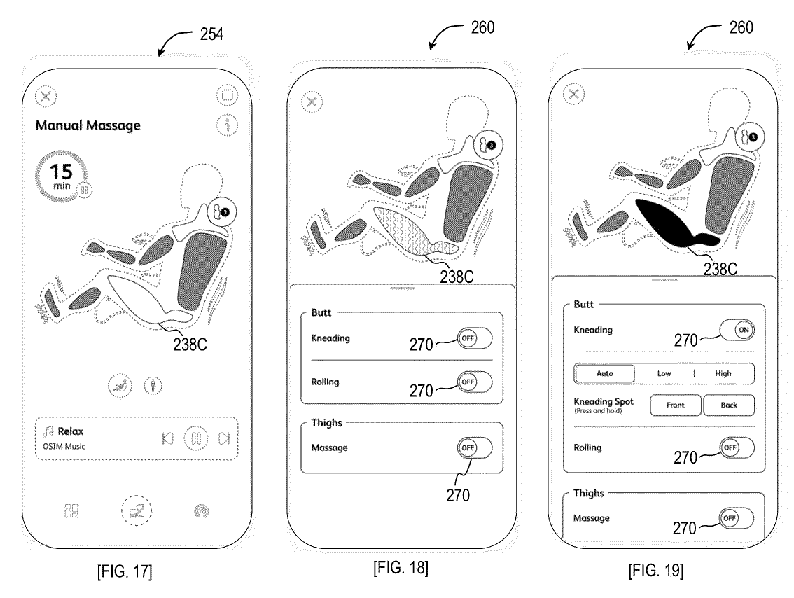

The massage chair 106 may be operable to apply massage, play music (FIG. 17), provide interactive content, and receive updates of new massage programs from an external input device, such as the terminal device 104. In one embodiment, the massage chair 106 is further provided with a remote controller 150 to facilitate its operation. In particular, the remote controller 150 can have a display capable of showing a list of massage programs for a user’s selection.

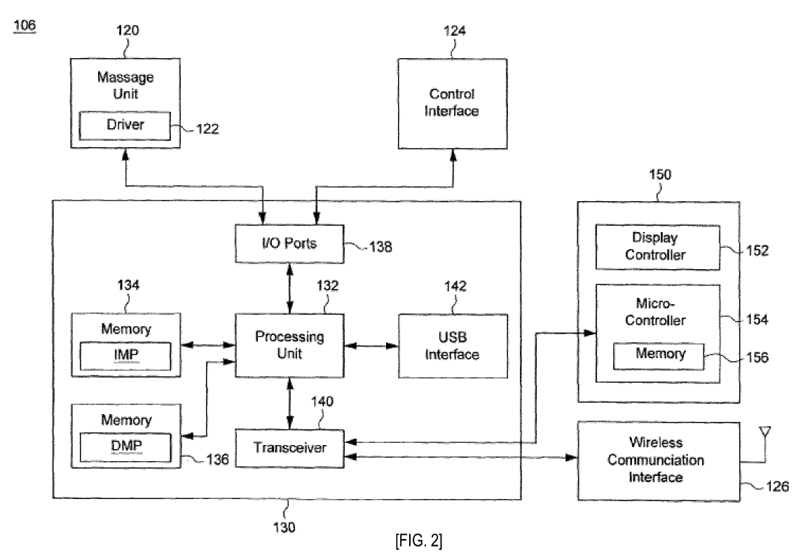

FIG. 2 is a simplified block diagram illustrating one embodiment of the massage chair 106. The massage chair 106 includes a massage unit 120, a driver 122 associated with the massage unit 120, a control interface 124, a wireless communication interface 126, a microcontroller 130 and the remote controller 150. The massage unit 120 can include one or more massage mechanisms operable to apply various types of massage actions, such as kneading and/or tapping actions, scrapping actions and the like for massaging various body parts of a user. The different body parts include but are not limited to, shoulder, neck, lumbar, arm, wrist and back, etc. Examples of the massage mechanisms in the massage unit 120 include a motor, an actuator, a pump, a solenoid, etc. (all not shown). The massage mechanism for massaging the shoulder of a user includes the shoulder massage roller 200 mounted in a backrest 202 of the massage chair 106. This massage roller 200 and other massaging mechanisms are well known to those skilled in the art. The massage chair 106 also includes multiple positional sensors (not shown) located along a length of the backrest 202 for detecting a position of the shoulder massage roller 200 as it moves past them. In one embodiment, the massage chair 106 may include twelve spaced apart positional sensors located at corresponding positions along the backrest 202 of the massage chair 106, although any number of positional sensors can be used.

The driver 122 may be one or more circuits that provide the control interface between the microcontroller 130 and the massage unit 120 and are operable to drive operation of the massage mechanisms of the massage unit 120 according to control signals outputted by the microcontroller 130.

The control interface 124 is connected to sensors, including the positional sensors, and limit switches arranged in the massage apparatus 106, and can deliver various detection signals to the microcontroller 130 to provide information such as physical height of the user, limits of movements, motor revolutions, position of the shoulder massage roller, etc.

The wireless communication interface 126 can include a Bluetooth interface and/or Wi-Fi interface that enables data exchange between the microcontroller 130 of the massage chair 106 and other external devices in a wireless manner.

The microcontroller 130 controls and supervises the operation of the massage chair 106. In one embodiment, the microcontroller 130 can exemplary be a 32-bit Reduced Instruction Set Computing (RISC) microcontroller. The microcontroller 130 can select one of a number of massage programs stored internally, execute the massage program through the massage unit 120 to apply a sequence of massage actions on a user’s body. The microcontroller 130 interacts with the terminal device 104 via the wireless communication interface 126. In one embodiment, the microcontroller 130 can include a processing unit/processor 132, a first and a second memory 134, 136 for storing massage program codes or instructions, input/output (I/O) ports 138 through which the processing unit 132 can exchange signals with the driver 122 of the massage unit 120 and the control interface 124, a transceiver 140 for data exchange with the communication interface 126, and a Universal Serial Bus (USB) interface 142.

The first memory 134 stores preset programming codes of massage programs IMP made initially available in the massage chair 106. The second memory 136 can store the programming codes of massage programs DMP that are loaded into the massage chair 106 by a user from an external device. The massage programs DMP may include one or more user customizable massage programs. In one embodiment, the first memory 134 may for example be a flash read-only memory (ROM), and the second memory 136 may for example be an electrically-erasable programmable read-only memory (EEPROM). Some massage programs DMP may be downloaded from a server computer (e.g., the server computer 103) into the terminal device 104, and then transferred from the terminal device 104 to the massage chair 106 for storage in the second memory 136. The massage programs DMP may be transferred from the external device to the massage chair 106 via the wireless communication interface 126 or the USB interface 142.

The transceiver 140 can be a Universal Asynchronous Receiver and Transmitter through which data can be received by the processing unit 132 of microcontroller 130 and transmitted to a component outside the microcontroller 130.

The remote controller 150 is connected to the microcontroller 130. The remote controller 150 can include a display screen driven by a display controller 152, and a microcontroller 154 operable to receive user’s inputs on the remote controller 150, to control graphical content shown on the display screen of the remote controller 150, and to interact with the microcontroller 130. In one embodiment, the microcontroller 154 of the remote controller 150 can include an internal memory 156 that stores graphical icons associated with the massage programs IMP and DMP. These graphical icons can be displayed on the screen of the remote controller 150 for facilitating the setting, control and operation of the massage chair 106 by the user. The functions provided by the remote controller 150 can also be additionally or alternatively provided on the terminal device 104.

The terminal device 104 may include hardware similar to those in the remote controller 150. For example, the terminal device 104 can include a touch screen display 204 driven by a suitable touch and display controller, and a microcontroller operable to receive user’s touch inputs on the touch screen display 204, to control graphical content shown on the touch screen display, and to interact with the microcontroller 130 of the massage chair 106. In one embodiment, the microcontroller of the terminal device 104 can include a memory that stores program instructions that is executable by the microcontroller therein for performing a number of functions/features.

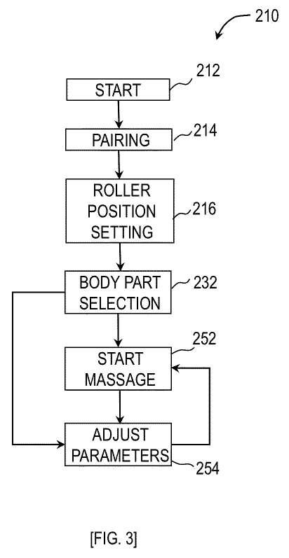

An operation of the massage system 100 according to another embodiment of the present disclosure is next described with the aid of FIG. 3. FIG. 3 is a flow diagram showing a method 210 of operating the massage system 100. The method 210 starts in a START step 212, wherein a user will sit on the massage chair 106 and powers it on. During this START step 212, the massage chair 106 will be transmitting data via its wireless communication interface that can be picked up by a terminal device 104 in its proximity. The method 210 next proceeds to a PAIRING step 214, wherein the terminal device 104 detects the data transmission of the massage chair 106 and data communicatively connects with the massage chair 106. Specifically, when the terminal device 104 is powered on, it is able to detect the data transmission from the massage chair 106 and display such detection on the touch screen display 204. The user can then initiate a pairing of the terminal device 104 with the massage chair 106 on the touch screen to establish a data communication channel therebetween.

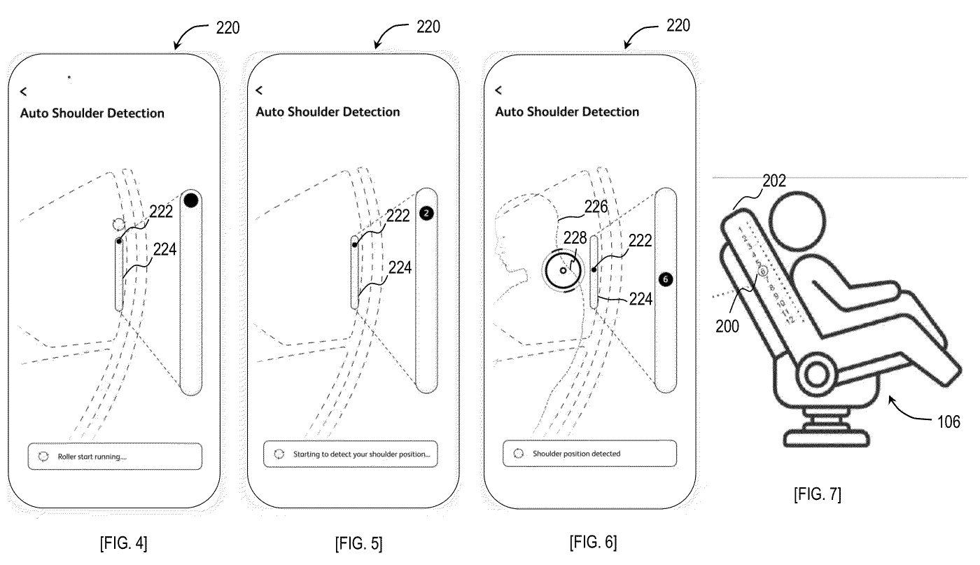

The method 210 next proceeds to a ROLLER POSITION SETTING step 216, wherein the shoulder massage roller 200 is positioned where the shoulder of the user is. In this step, the massage chair 106 can automatically detect a shoulder position of the user in an automatic roller positioning mode. Alternatively or additionally, the shoulder massage roller 200 may be positioned at a position selected by the user in a manual shoulder roller positioning mode. Automatic positioning of the shoulder position is carried out under the control of the microcontroller 103, wherein the shoulder massage roller 200 is moved up and down the backrest 202 of the massage chair 106 until a shoulder position of the user is automatically detected by a suitable sensor (not shown) coupled to the shoulder massage roller 200. In the manual shoulder roller positioning mode, the user gets to select where to position the shoulder massage roller 200. The shoulder massage roller 200 is moved under the control of the microcontroller 103 along the length of the backrest 202 of the massage chair 106 to impinge against the user, and the user can stop the shoulder massage roller 200 in any desired position. After positioning of the massage roller 200 is completed, the massage chair 106 records the shoulder massage roller position for the user in the memory 136. The shoulder massage roller position may alternatively or additionally be stored on the server computer 103. In the ROLLER POSITION SETTING step 216, a roller positioning screen 220 as shown in FIGS. 4-6 is shown on the touch screen display 204 of the terminal device 104. The roller setting screen 220 includes a representation of the shoulder massage roller 200 in the massage chair 106 in the form of a circle indicium 222, although an indicium of any other shapes may be used. The shoulder roller positioning screen 220 also includes a representation of the backrest of the chair in the form of a bar 224 having twelve discrete positions corresponding to the twelve positions in the massage chair 106 where the positional sensors are located. As the shoulder massage roller 200 moves up and down the backrest 202 of the massage chair 106, each positional sensor in the backrest 202 will in turn detect the shoulder massage roller 200 as it moves past the positional sensor or when it comes into a proximity of the positional sensor. The massage chair 106 will send the position information of the shoulder massage roller 200 as each position sensor senses the shoulder massage roller 200 to the terminal device 104 via the connection and the terminal device 104 will update the position of the circle indicium 222 along the bar 224 accordingly in the shoulder roller positioning screen 220. FIG. 4 is drawing of a roller positioning screen 220 showing the circle indicium at a position 1 when the massage chair 106 reports that the shoulder massage roller 200 is at a corresponding topmost position, position 1, in the massage chair 106. When the massage chair 106 reports that the shoulder massage roller 200 is at a position 2 next to position 1, the circle indicium 222 on the roller positioning screen 220 will be shown at a corresponding position 2 as shown in FIG. 5. In this manner the circle indicium 222 is shown on the touch screen display 204 in synchronization with the movement of the actual shoulder massage roller 200 in the massage chair 106. This synchronized update of the position of the circle indicium 222 on the shoulder roller positioning screen 220 continues until the shoulder position is detected in the automatic shoulder roller positioning mode or selected by the user in the manual shoulder roller positioning mode. Before the shoulder position is detected or set, no human body representation 226 is shown on the shoulder roller positioning screen 220 as shown in FIG. 4 and FIG. 5. It is only when the shoulder massage roller 200 is stopped when the shoulder position is detected or set by the user that the human figure representation 226 will appear on the shoulder roller positioning screen 220 as shown in FIG. 6. FIG. 6 shows that the shoulder massage roller 200 is at a position 6 when the shoulder position is detected or selected by the user. A shoulder portion 228 of the human body representation 226 is shown adjacent the circle indicium 222 that is at position 6. The position of the human body representation 226 on the shoulder roller positioning screen 222 relative to the bar is thus determined by the final position of the circle indicium 222. In this manner, the user is able to see on the touch screen display 204 where the shoulder massage roller 200 is in the massage chair 106 with respect to his/her shoulder. This may facilitate setting of the roller position when the user next uses the massage chair 106.

In one embodiment, the massage chair 106 will go into the automatic shoulder roller positioning mode in the ROLLER POSITION SETTING step 216. In other embodiments, the user is provided with a screen (not shown) to select either automatic shoulder roller positioning or manual shoulder roller positioning. Selection of the manual shoulder roller positioning will instruct the massage chair 106 to go into the manual shoulder roller positioning mode, wherein the massage chair 106 continues to move the shoulder massage roller 200 without deciding where to finally position the shoulder massage roller 200. The position of the circle indicium 222 will be updated in tandem with shoulder massage roller position sensed by the positional sensors as described above. The massage chair 106 may move the shoulder massage roller 200 along the backrest in a continuous manner at a speed of about 0.1 m/s. Alternatively, the massage chair 106 may move the shoulder massage roller 200 at a faster rate of about 0.2 m/s between positional sensor positions and stopping intermittently at each positional sensor position to allow more time for the user to decide if the shoulder massage roller 200 has been positioned at his/her desired shoulder position. In the manual shoulder positioning mode, when the user decides that the shoulder massage roller is at a desired shoulder position, the user may tap on a call-to-action “Start Massage” button (not shown) and that will cause the massage chair 106 to stop the advancing of the shoulder massage roller 200. At this point the terminal device 104 will momentarily show the human body representation 226 in the shoulder roller positioning screen 220 as described above in relation to the automatic shoulder roller positioning mode.

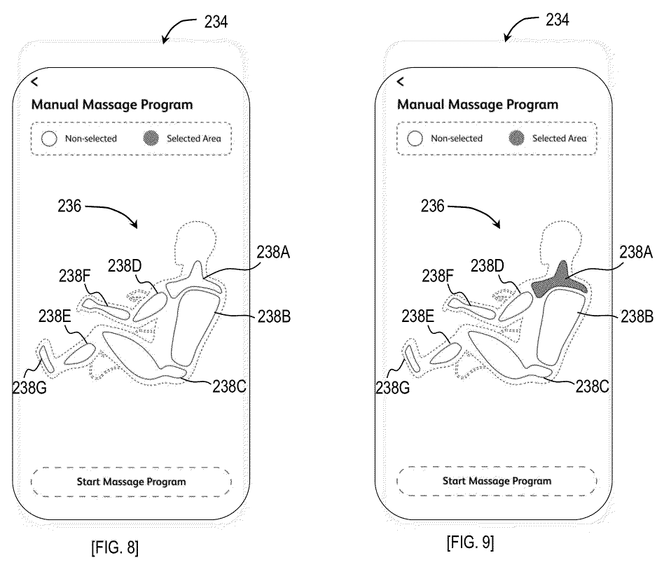

After the position of the shoulder massage roller 200 is set, the method 210 next proceeds to a BODY PART SELECTION step 232, wherein the terminal device 104 displays in a body part selection screen 234 a human body representation 236. This human body representation 236 is shown in FIG. 8 in a go-kart driver position although any other positions are also possible. The body part selection screen 234 also includes a number of body part representations 238A-238G. Each of these body part representations 238A-238G is individually selectable for actuating a corresponding massage mechanism of the massaging unit 120. One or more of these body part representations 238A-238G have an irregular shape and is sized to at least substantially cover a corresponding body part of the human body representation 236. For example, the irregular shape may cover at least 70% of the body part of the human body representation 236. As another example, for the head and shoulder portion of the human body, the body part representation 238A may take the shape of a cloth hanger. Each body part representation 238A-238G may be in a colour, such as, grey when in an unselected state and another colour such as light blue, when selected. FIG. 8 shows a body part selection screen with all body part representations 238A-238G unselected.

The terminal device 104 is able to detect selection of each of these body part representations 238A-238G by the user touching it on the touch screen display 204. Once a selection is detected, the terminal device 104 changes the colour of the body part representation 238A-238G selected to for example light blue in colour to indicate its selected state. A further touch on this same selected body part representation 238A-238G will deselect it when its colour will be changed back to grey to indicate its deselected state. In this manner, repeated touch of a body part representation 238A-238G in the body part selection screen 234 will toggle the body part representation 238A-238G between a selected state and a deselected state. FIG. 9 shows a body part selection screen 234 with only a head and shoulder body part representation 238A shown selected.

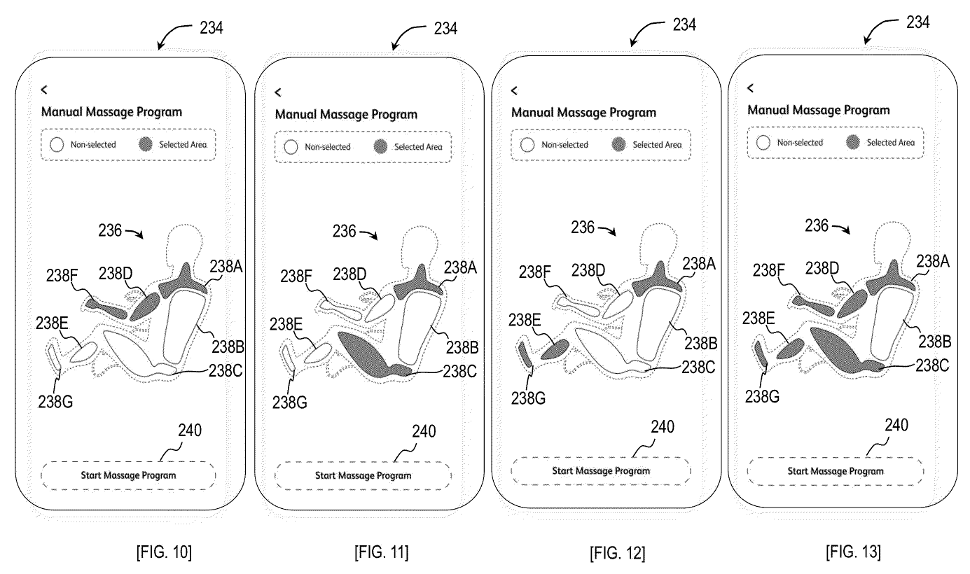

As each body part is individually selectable, a user can select any combination of body parts to create his/her own customized massage program. For example, the user may select a combination of head and shoulder, and arms as shown in FIG. 10. The user may also select a combination of head and shoulder, and butt and thighs as shown in FIG. 11. Or the user may select a combination of head and shoulder, calves and feet as shown in FIG. 12. Or the user may select a combination of head and shoulder, arms, butt and thighs, calves and feet as shown in FIG. 13. Although not shown, any other combinations are also possible. On any of the body part selection screen 234 shown in FIG. 10 - FIG. 13, the user may tap on a call-to-action “Start Massage Program” button 240 to start a massage program that massages only the selected body parts. This customized massage program may be stored in one or more of the massage chair 106, terminal device 104 and the server computer 103.

A method of obtaining an irregular shape body part representation 238A-238E and detecting a touch of such an irregular shape body part representation 238A-238G on the touch screen display 204 according to an embodiment of the present disclosure is next described with the aid of FIG. 14 -FIG. 16. FIG. 14 shows an irregular shape thigh and butt body part representation 238C that includes several adjoining border segments 242A-242C. Each border segment 242A-242C may be defined using a cubic Bezier curve or any other means. For the cubic Bezier curve, those skilled in the art knows that four points P₀, P₁, P₂ and P₃ in a plane define the cubic Bezier curve. The curve 242B starts at P₀ going toward P₁ and arrives at P₃ coming from the direction of P₂. Usually, the curve 242B will not pass through P₁ or P₂; these points are only there to provide directional information. The distance between P₁ and P₂ determines “how far” and “how fast” the curve 242B moves towards P₁ before turning towards P₂. In this manner, one or more border segments 242A-242C defining the body part representation 238A-238G may be defined using a suitable cubic Bezier curve and adjusting position of P₁ and P₂ to follow a contour of the corresponding body part of the human representation 236 as shown in FIG. 14.

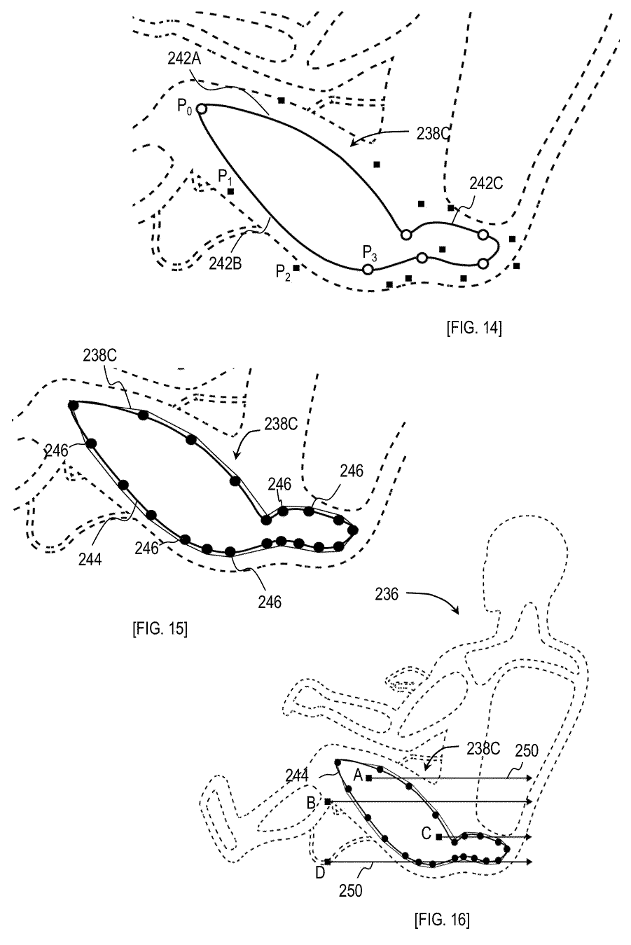

After the border segments 242A-242C are defined, an irregular polygon 244 is defined based on the irregular shape 238C. Vertices 246 of the irregular polygon 244 may lie on the border segments 242A-242C of the irregular shape as shown in FIG. 15. In other embodiments, the vertices 246 may lie outside or inside of the irregular shape 238C. The irregular polygon 244 is accordingly superimposed on the irregular shape 238C. It is also apparent that the more vertices 246 there are in each border segment 242A-242C, the closer the irregular polygon 244 is to being congruent with the irregular shape 238C and thus more accurately representing it. To determine if a touch is within the irregular shape 238C, the Jordan curve theorem may be used to detect if a touch point A-D (FIG. 16) corresponding to the touch is within this irregular polygon 244.

FIG. 16 shows four touch points A-D and how the Jordan curve theorem determines if each of these four touch points A-D is within the irregular polygon 244. For each touch point A-D, the theorem basically runs a horizontal line 250 out from the touch point A-D and counts the number of edges of the irregular polygon 244 the horizontal line 250 crosses. At each crossing of an edge, the horizontal line 250 switches between inside and outside the irregular polygon 244. For the touch point A, which is inside the irregular polygon 244, the corresponding horizontal line 250 crosses only one edge of the irregular polygon 244. For the touch point B, the corresponding horizontal line 250 crosses two edges of the irregular polygon 244. For touch point C, the corresponding horizontal line 250 crosses three edges of the irregular polygon 244. And for touch point D, the corresponding horizontal line 250 crosses four edges of the irregular polygon 244. It is noted that when a horizontal line 250 crosses an odd number of edges of the irregular polygon 244, the corresponding touch point A-D is within the irregular shape 238C, such as for touch points A and C. And when the horizontal line 250 does not cross any edge or crosses an even number of edges of the irregular polygon 244, the corresponding touch point is outside the irregular shape 244, such as for touch points B and D.

Once the user has selected one or more body parts according to that described above, the method 210 next proceeds to a START MASSAGE step 252, wherein the massage chair 106 will actuate the massage mechanisms corresponding to the selected body part representations 238A-238G to massage the corresponding body parts of the user. The massage mechanisms are actuated according to a default parameter settings of the massage chair 106. In this massage mode of the massage chair 106, a massage screen 254 such as that shown in FIG. 17 will be shown on the touch screen display 204 of the terminal device 104.

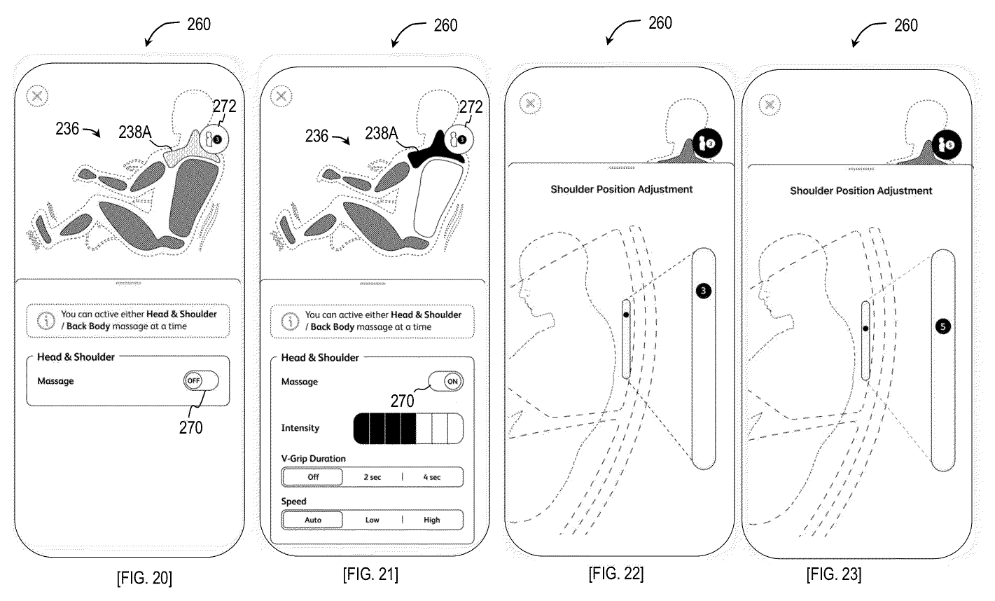

During the massage sequence in the START MASSAGE step 252 or before the start of the massage sequence in the BODY PART SELECTION step 232, the user is able to adjust the parameters of each massage mechanism of the massage chair 106. The user can do so by pressing on the body part representation 238A-238G. Other inputs such as but not limited to a slide gesture and a double-tap may also be used. Pressing is distinguished from a tap in that the amount of time a finger is in contact with the touch screen is longer. Such an action will not toggle the selection of the body part representation 238A-238G but will cause the method 210 to go into an ADJUST PARAMETER step 254, wherein the terminal device 104 will display on the touch screen display 204 a parameter adjustment screen 260 corresponding to the pressed body part representation 238A-238G. For example, when the head and shoulder body part representation 238A is pressed, the parameter adjustment screen 260 shown in FIG. 20 will be displayed. The parameter adjustment screen 260 includes the human body representation 236 with the selected body part representation 238A-238G in a different colour, e.g., black, to distinguish it from the other body part representations 238A-238G. At this point, any activated massage mechanism will be stopped. The parameter adjustment screen 260 includes a start adjustment switch 270. When the user turns this start adjustment switch 270 on, the screen 260 in FIG. 21 will be displayed where the parameters available for adjustment are now shown. The parameter adjustment screen 260 in FIG. 21 includes one or more parameters for adjustment displayed adjacent the human body representation 236. This is so that it is clear to the user which massage mechanism the parameters are associated with. For the parameter adjustment screen 260 in FIG. 21, parameters available for adjustment include intensity, V grip duration and speed of the head and shoulder massage mechanism. Adjustment may be in the form of a slider bar, buttons, text entry, knobs, and the like. Selection of start adjustment button 270 will also trigger the actuation of the massage mechanism for massaging the selected body part so that adjustment of the parameters may be felt and selected by the user. A shoulder roller position button 272 is also provided in each of the parameter adjustment screens 260 shown in FIG. 20 and FIG. 21 for adjustment of the shoulder massage roller position. When this shoulder roller position button 272 is tapped, the massage chair 106 will be brought back to a shoulder roller positioning mode where an appropriate screen shown in FIG. 22 and FIG. 23 will be displayed on the touch screen display 204.

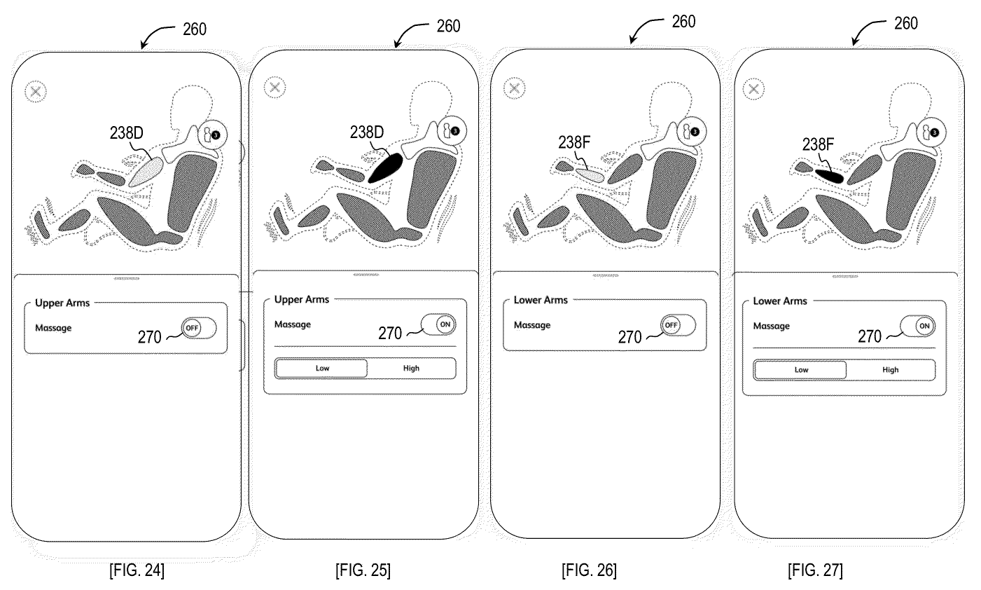

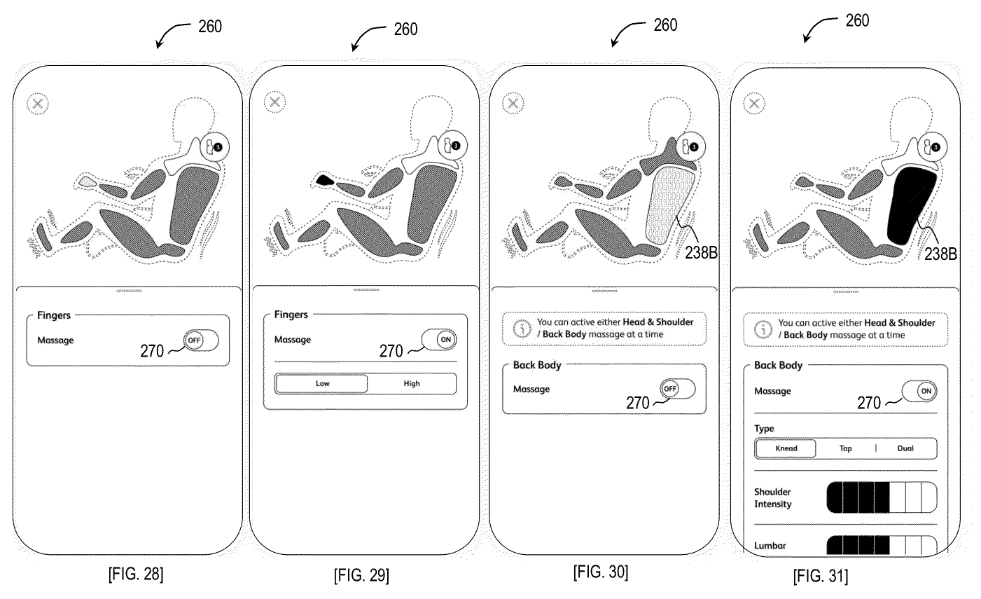

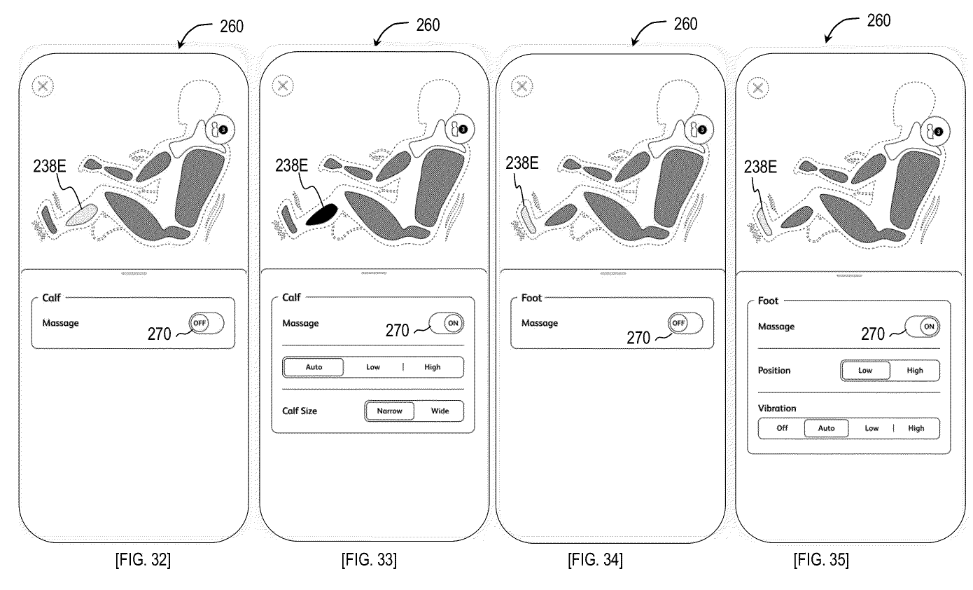

In this manner, parameters for the massage mechanism corresponding to each body part may be adjusted. FIG. 18 and FIG. 19 show parameter adjustment screens 260 for adjusting parameters of a massage mechanism associated with massaging the butt and thighs. Three start adjustment buttons 270 associated with different massaging actions, namely kneading, rolling and massage, are included in the screen 260 shown in FIG. 18. FIG. 19 shows a screen 260 wherein the start adjustment switch 270 associated with kneading is switched on. FIG. 24 and FIG. 25 show parameter adjustment screens 260 for adjusting parameters of a massage mechanism associated with massaging the upper arms. FIG. 26 and FIG. 27 show parameter adjustment screens 260 for adjusting parameters of a massage mechanism associated with massaging the lower arms. FIG. 28 and FIG. 29 show parameter adjustment screens 260 for adjusting parameters of a massage mechanism associated with massaging the fingers. FIG. 30 and FIG. 31 show parameter adjustment screens 260 for adjusting parameters of a massage mechanism associated with massaging the back. FIG. 32 and FIG. 33show parameter adjustment screens 260 for adjusting parameters of a massage mechanism associated with massaging the calves. And FIG. 34 and FIG. 35 show parameter adjustment screens 260 for adjusting parameters of a massage mechanism associated with massaging the feet. After the parameters associated with any of the parameters adjustment screens 260 shown in FIG. 18 - FIG. 35 have been selected, the method 210 returns to the START MASSAGE step 252 to start or continue with the massage sequence with the adjusted parameters.

Advantageously, the user interface associated with massage system 100 described above is user friendly and intuitive. A user can easily create a customized massage program for massaging user selected body parts without the aid of user guides and complicated screen navigations, leading to a better overall user experience.

Although the present invention is described as implemented in the above-described embodiments, it is not to be construed to be limited as such. For example, although it is described in the context of a massage chair 106, the system can be implemented in any massage apparatus including, but not limited to, a massage belt, a foot massage apparatus, and the like.

As another example, positional sensors are described to be located at corresponding positions along the backrest 202 of the massage chair 106 for detecting the position of the shoulder massage roller 200. Other mechanisms for detecting the position of the shoulder massage roller 200 may also be used. For example, these mechanisms may include a single optical or audio sensor appropriately located so that a distance between the senor and the shoulder massage roller 200 may be detected.

As yet another example, the terminal device 104 is described as receiving positional information of the shoulder massage roller 200 from the massage chair 106 for positioning the circle indicium 222 on its touch screen display 204. This is not to be construed to be limited as such. In other embodiments, the terminal device 104 may receive just a current or start position of the shoulder massage roller 200 from the massage chair 106 and thereafter advance the circle indicium 222 independently of the massage chair 106 according to a known speed and direction of a movement of the shoulder massage roller 200 in the massage chair 106 so that movement of the two remain synchronized.

As yet a further example, the body part representations are described as being drawn using a cubic Bezier curve. Other means of drawing these body part representations, including but not limited to, using bit map representations, may also be used.

It should be further appreciated by the person skilled in the art that one or more of the above modifications or improvements, not being mutually exclusive, may be further combined to form yet further embodiments of the present invention.

1. A massage system comprising:
a massage chair having a plurality of massaging mechanisms, each massaging mechanism for massaging a corresponding one of a plurality of body parts of a user; and
an input device in data communication with the massage chair, the input device having a touch screen display; wherein the input device is operable to:
display on the touch screen display a body part selection screen that includes a human body representation and a plurality of body part representations corresponding to the body parts of the user; each body part representation being individually selectable for actuating a corresponding massaging mechanism to massage a corresponding body part of the user; wherein at least one of the plurality of body part representations being of an irregular shape and of a size that at least substantially covers a corresponding body part of the human body representation.

2. The massage system according to claim 1, wherein the irregular shape includes a plurality of border segments, each border segment being defined according to a cubic Bezier curve.

3. The massage system according to claim 1, wherein an irregular polygon is defined based on the irregular shape.

4. The massage system according to claim 3, wherein detecting whether the irregular shape is selected by a touch is based on determining whether the touch is within the irregular polygon.

5. The massage system according to claim 4, wherein determining whether the touch is within the irregular polygon is based on a Jordan curve theorem.

6. The massage system according to claim 3, wherein vertices of the irregular polygon lie on a border of the irregular shape.

7. The massage system according to claim 1, wherein the irregular shape includes a plurality of border segments and at least one of the plurality of border segments follows a contour of the corresponding body part of the human body representation.

8. The massage system according to claim 1, wherein each body part representation is further selectable for adjusting at least one parameter of the corresponding massaging mechanism.

9. The massage system according to claim 8, wherein each body part representation is selectable, via a tap for selecting the corresponding massaging mechanism; and is selectable, via at least one of a press, slide gesture and a double-tap for adjusting the at least one parameter of the corresponding massaging mechanism.

10. The massage system according to claim 8, wherein the input device is further operable to display a parameter adjustment screen when a body part representation is selected for adjusting at least one parameter of the corresponding massaging mechanism, the parameter adjustment screen including:
the human body representation with the selected body part representation distinguished from the other body part representations; and
at least one parameter for adjustment adjacent the human body representation.

11. The massage system according to claim 10, wherein the parameter adjustment screen further includes a massage button this is actuatable before adjustment of the at least one parameter can proceed.

12. The massage system according to claim 1, wherein the plurality of massaging mechanisms comprise a shoulder massaging roller whose position along a backrest of the massage chair is selectable during a shoulder roller positioning mode, and the input device is further operable to display in a shoulder roller positioning screen a representation of the shoulder massaging roller and a representation of the backrest, wherein a position of the shoulder massaging roller representation along the backrest representation is shown in synchronization with a movement of the shoulder massaging roller along the backrest of the massage chair.

13. The massage system according to claim 12, wherein the massage chair comprises a plurality of sensors for detecting the position of the shoulder massaging roller along the backrest, and the massage chair sends positional information to the input device as each of the plurality of sensors detects the shoulder massaging roller in its proximity for the input device to position the shoulder massaging roller representation in a corresponding position in the shoulder roller positioning screen.

14. The massage system according to claim 12, wherein the shoulder roller positioning screen includes a human body representation that appears only after the position of the shoulder massaging roller has been selected; the human body representation having a shoulder portion that is adjacent the shoulder massaging roller representation.

15. A device in data communication with a massage chair having a plurality of massaging mechanisms, each massaging mechanism for massaging a corresponding one of a plurality of body parts of a user, the device comprising:
a touch screen display;
wherein the input device is operable to:
display on the touch screen display a body part selection screen that includes a human body representation and a plurality of body part representations corresponding to the body parts of the user; each body part representation being individually selectable for actuating a corresponding massaging mechanism to massage a corresponding body part of the user; wherein at least one of the plurality of body part representations being of an irregular shape and of a size that at least substantially covers a corresponding body part of the human body representation.

16. The device according to claim 15, wherein the irregular shape includes a plurality of border segments, each border segment being defined according to a cubic Bezier curve.

17. The device according to claim 16, wherein an irregular polygon is defined based on the irregular shape.

18. The device according to claim 17, wherein detecting whether the irregular shape is selected by a touch is based on determining whether the touch is within the irregular polygon.

19. The device according to claim 17, wherein determining whether the touch is within the irregular polygon is based on a Jordan curve theorem.

20. The device according to claim 17, wherein vertices of the irregular polygon lie on a border of the irregular shape.
